(19) United States
(12) Patent Application Publication
(10) Pub. No.: US 2006/0003701 A1
(43) Pub. Date: Jan. 5, 2006

(54) Alignment system for communications

(76) Inventors: Bassel H. Daoud, Parsippany, NJ (US); Ivan Pawlenko, Holland, PA (US); Richard R. Schwartz, (US)

Correspondence Address: DUANE MORRIS, LLP;IP DEPARTMENT, 30 SOUTH 17TH STREET, PHILADELPHIA, PA, 19103-4196, US

(21) Appl. No.: 10/881,568

(22) Filed: Jun. 30, 2004

(51) Int. Cl. H04B 1/00; H04B 15/00

(52) U.S. Cl. 455/65; 455/506

(57) ABSTRACT

An alignment mechanism for establishing line-of-sight alignment between a transmitter (100) and a receiver (102) has, a laser pointer (300) that emanates a laser beam along a line-of-sight to illuminate the receiver (102) with a bright spot. An unmodulated reflector (304) at the receiver (102) reflects the emanated laser beam for return path transmission toward the laser pointer (300) to confirm alignment of the line-of-sight with the receiver (102). The transmitter (100) is aligned substantially along the line-of-sight and is fixed in position. A shutter in the form of a chopping wheel (400) modulates the emanated laser beam. The receiver (102) is linked to a communications apparatus (500) having an external antenna (502).

### FIELD OF THE INVENTION

The invention relates generally to a system for aligning a transmitter and receiver for direct, line-of-sight communications, and particularly to, a system for aligning communications transmitted by laser or microwave carrier.

### BACKGROUND

A short range communications link is suitably aligned by line-of-sight to establish audio and/or video coverage of an event. Examples of events that require audio and video coverage include and are not limited to, a sporting event, a surveillance event and a video conference. These events have the following similarities. For example, each event is of short duration, and is performed entirely at a fixed site, such as, a sports stadium or a meeting room in a building. One or more video cameras are located at or near the site, and produce a number of audio and video signals that record, i.e., cover, the event. Sporting events are capable of coverage by one-way communications signals. Video conferences require coverage by two-way communications signals. A transmitter transmits the communications signals to a receiver in preparation for processing the communications signals for communication to a listener or viewer. The terminology, transmitter, applies to an apparatus that is either a transmitter of one-way communications signals, or a transceiver of two-way communications signals.

A one-time event, such as, a sporting event, or a surveillance event, is covered by mobile communications equipment. For example, FIG. 1 discloses a mobile transmitter (100) is temporarily set up to record the event. A wireless line-of-sight communications link is established between the transmitter (100) and a mobile receiver (102). The mobile receiver (102) is installed at a temporary location, such as, on an equipment van (104), or in a hotel (106) having a room with a window (108) in line-of-sight view of the transmitter (100). The transmitter output is transmitted in the form of a wireless communications signal over a laser carrier or over a microwave carrier to the mobile receiver (102). The transmitter (100) may be a transmitter (100) for one-way communications transmission. The receiver (102) may be a receiver (102) of one-way communications transmission. Alternatively, the transmitter (100) and the receiver (100), one or both, may be a transceiver of two-way communications transmission.

A wireless, line-of-sight communications link must be established between the transmitter (100) and receiver (102). Usually, the task is performed by a transmitter operator who must visually aim the transmitter output. Further the operator must select the correct equipment van (104) from a number of possible equipment vans (104) that are randomly parked, or the operator may be required to select the correct window (108) from a number of possible windows. Further, a line-of-sight alignment between the transmitter (100) and the receiver (102) must be verified. The line-of-sight alignment with the receiver (102) is verified as having been established with the correct transmitter (100).

Repeating events, such as, video conferences can be covered by mobile or fixed communications equipment. FIG. 2 discloses that a need exists for establishing a two-way, line-of-sight, video communications link between a transmitter in a building (200) and receiver located in a different building (202) without requiring rooftop antennae. Usually, the task is performed by a transmitter operator who must visually aim the transmitter output at the correct window (108) at which a receiver is located. The operator must visually select the correct window (108) from a number of windows of a building (202) in which the receiver is located. Further, the line-of-sight alignment needs verification that the correct transmitter and receiver have been selected for communications alignment.

### SUMMARY OF THE INVENTION

According to the invention, a transmitter operator visually aims the transmitter at a correct equipment van that is visually selected from a number of equipment vans that are randomly parked. Alternatively, the transmitter equipment operator visually aims the transmitter at a correct window that has been visually selected from a number of windows of a building in which the receiver is located. Further, after a transmitter has pointed along a line-of-sight to the receiver, the line-of-sight alignment is subject to verification whether a receiver is present, and whether the receiver has been aligned with the correct transmitter.

According to an embodiment of the invention, a transmitter and receiver are aligned for wireless communications by, pointing a beam of radiation toward a receiver to illuminate the receiver with a visually observed bright spot, reflecting at least some of the radiation from a reflector at the receiver, and adjusting the transmitter position to align with the reflected radiation.

According to a further embodiment of the invention, a transmitter and receiver are aligned by modulating a pointer beam of radiation, and observing radiation reflected from a reflector at the receiver to modulate in synchronization with the pointer beam to verify the identity of the pointer beam.

### BRIEF DESCRIPTION OF THE DRAWINGS

FIG. 1 is a schematic view of a transmitter and multiple communications vans for establishing a communications link between the transmitter and a receiver at a selected one of the vans.

FIG. 2 is a schematic view of building-to-building alignment of a transmitter and receiver for establishing a communications link.

FIG. 3 is a schematic view of a laser pointer aligned with a reflector at a receiver and a transmitter establishing a communications link with the receiver.

FIG. 4 is a schematic view of a chopping wheel that modulates a pointer beam of radiation and a reflector that reflects the radiation with a synchronized modulation.

FIG. 5 is a diagram of an aligned wireless transmitter and receiver coupled to a communications apparatus having an exterior antenna for wireless communications.

### DETAILED DESCRIPTION

This description of the exemplary embodiments is intended to be read in connection with the accompanying drawings, which are to be considered part of the entire written description. In the description, relative terms such as “lower,” “upper,” “horizontal,” “vertical,”, “above,” “below,” “up,” “down,” “top” and “bottom” as well as derivative thereof (e.g., “horizontally,” “downwardly,” “upwardly,”etc.) should be construed to refer to the orientation as then described or as shown in the drawing under discussion. These relative terms are for convenience of description and do not require that the apparatus be constructed or operated in a particular orientation. Terms concerning attachments, coupling and the like, such as “connected” and “interconnected,” refer to a relationship wherein structures are secured or attached to one another either directly or indirectly through intervening structures, as well as both movable or rigid attachments or relationships, unless expressly described otherwise.

The invention relates to alignment of a line-of-sight communication link between a receiver and a transmitter, for example, a laser or microwave transmitter and receiver.

The invention relates to a method and apparatus for line-of-sight alignment of a closed channel communications link for laser transmitted communications or microwave transmitted communications.

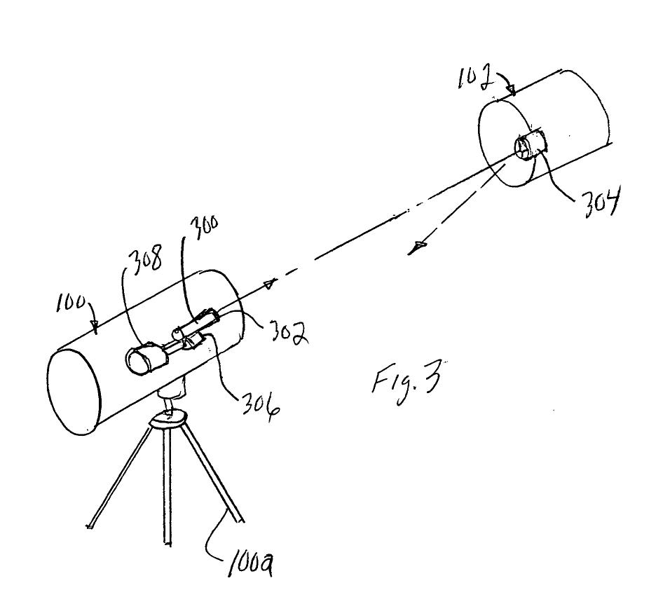

FIG. 3 discloses a transmitter (100) mounted on a base (100a), for example, a tripod. The transmitter output is in the form of a wireless communications signal transmitted by a laser or microwave carrier. The transmitter (100) is aligned with a distant or remote receiver (102) to establish line-of-sight communications with the receiver (102). According to the invention, a radiation emitting device, including, and not limited to a pen style, laser pointer (300) emanates a visible spectrum laser beam through a diffuser (302) that includes, and is not limited to, a lens or refraction element.

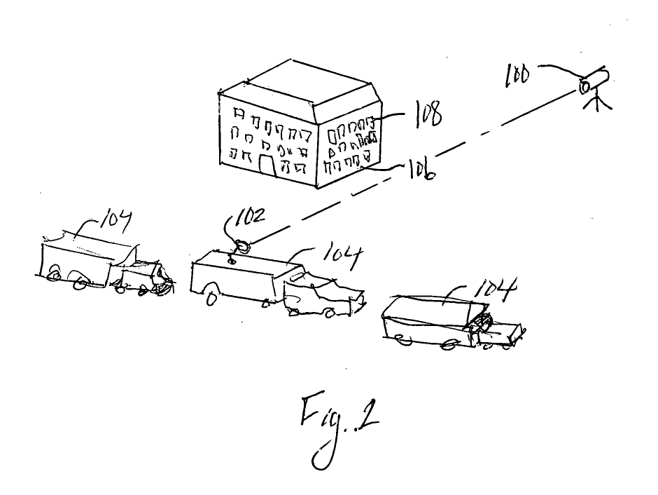

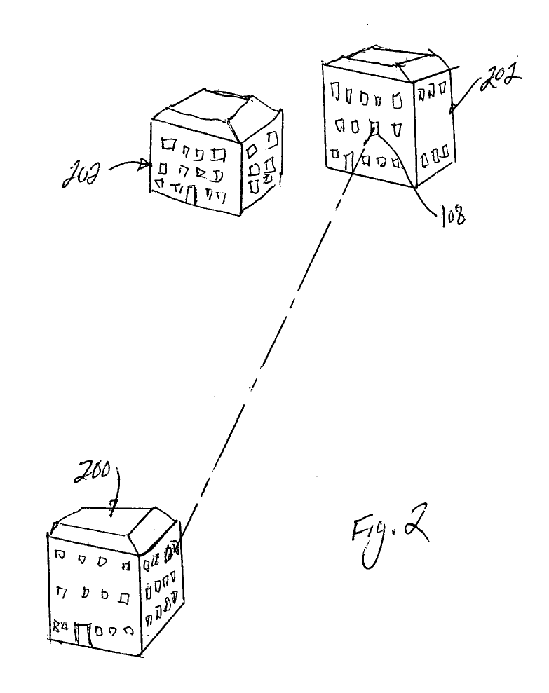

To align the transmitter (100) with the receiver (102), an operator begins the process by manually pointing the laser pointer (300) toward a candidate target. A candidate target is a target that potentially could have the desired receiver (102). For example, the candidate target can be an equipment van (104) disclosed by FIG. 1, or a window (108) as disclosed by FIGS. 1 and 2. The laser pointer (300) is a source of laser radiation that emanates from the laser pointer (300) and is incident on the diffuser (302) to nominally enlarge the beam spread. Further, the beam is incident on a distant candidate target. The energy of the incident beam illuminates the candidate target with an enlarged diffused bright spot, and not merely a narrow bulls-eye point of illumination.

According to the invention, FIG. 3 further discloses a reflector (304) mounted on a receiver (102) intended to establish a communications link with the transmitter (100). According to an embodiment of the invention the reflector (304) is an unmodulated reflector of incident laser radiation. The reflector (304) reflects the incident laser radiation backward toward the source. At the source, the reflected radiation appears as a bright point of light within the boundary of the bright spot of illumination produced by the beam energy incident on the candidate target, i.e., the equipment van (104) or window (108).

According to an embodiment of the invention, the reflector (304) includes a retroreflector, which further includes, and is not limited to, a corner cube reflector. A further description of a retroreflector is disclosed in U.S. Pat. No. 6,663,246, incorporated herein by reference. The retroreflector reflects the incident radiation at an energy loss that is less than the energy loss of reflection from the ordinary and usual, non-mirror surfaces of the candidate target and the receiver (102) at the candidate target. The operator at the source observes the reflected radiation to appear as a bright point of light of higher intensity compared to the diffused bright spot of incident laser illumination. The appearance of the bright point of light is a visual cue that the laser output radiation is incident on the receiver (102) on which the reflector (304) is mounted. To more precisely align the transmitter (100) with the receiver (102), an operator adjusts the position of the laser pointer (300) by itself, while visually observing the bright spot of illumination to move over the candidate target, until it appears to be substantially concentric with the diffused bright spot of incident light. Thereby, the laser pointer (300) will be pointing toward the center of the diffused bright spot of incident laser illumination, which coincides with the optimum alignment of the pointer (300) on the transmitter (100) and the reflector (304) on the receiver (102). When the laser pointer (300) is separate from the transmitter (100), the operator adjusts the position of the transmitter (100) to align with the reflected laser illumination, for optimum alignment of the transmitter (100) and the receiver (102). Alternatively, the laser pointer (300) is mounted on the transmitter (100), such that the operator adjusts the positions of the transmitter (102) and the laser pointer (300) together, as a unit. Consequently, the transmitter (102) and receiver (102) are in direct, line-of-sight alignment for exchanging line-of-sight communications. The correct receiver (102) has been confirmed, because reflected radiation from the reflector (304) distinguishes the correct receiver (102) from other receivers without reflectors. Further, the line-of-sight alignment has been confirmed with the correct transmitter (100) that uses the reflected radiation.

Ambient conditions of high intensity ambient light can substantially reduce the intensity contrast of the reflected illumination compared to the overall incident illumination, making it harder for an operator to visually distinguish the diffused bright spot of laser illumination. According to a further embodiment of the invention, an optoelectronic transducer (306) detects the reflected radiation, i.e. reflected laser radiation, and produces an electrical voltage output that varies with the amplitude of the detected radiation. An optoelectronic transducer includes, and is not limited to, a known photodiode or other known photodetector. The voltage output of the transducer (306) activates an audible alarm (308) that varies in volume intensity with the amplitude of the detected radiation. The transducer (306) and alarm (308) are mounted with the laser pointer (300). The laser pointer (300) is either separate from the transmitter (100), or alternatively, is mounted on the transmitter (100) or is part of an assembly with the transmitter (100).

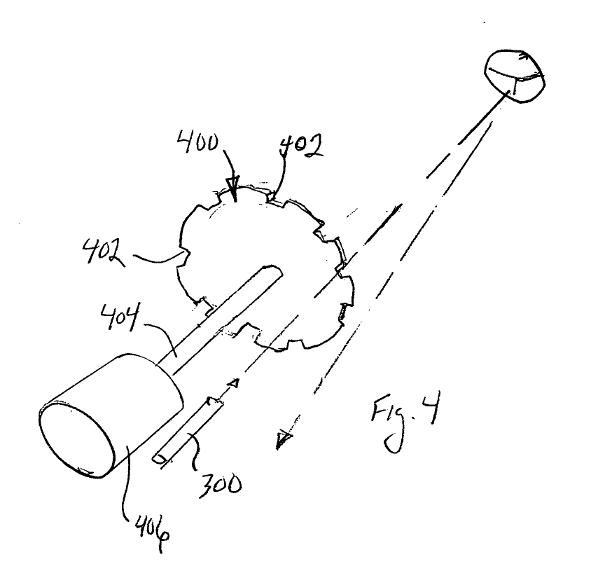

According to a further embodiment of the invention, a modulated light source produces coherent laser radiation. With reference to FIG. 4, the modulated light source includes a shutter in the form of a chopping wheel (400). For example, the chopping wheel (400) is a solid disc that has one or more apertures (402) that are spaced apart angularly about a central axis of rotation of the chopping wheel (400). The chopping wheel (400) is mounted on a rotatable shaft (404), and is rotated, either manually by an operator, or by an electric motor (406) driving the shaft (404). A constant speed motor (406) or a variable speed motor (406) controls the rotational velocity of the chopping wheel (400). The chopping wheel (404) rotates in front of the emanating radiation from the source, i.e., the laser pointer (300) and diffuser (302). The chopping wheel (400), rotates such that each of the apertures (402) momentarily intercepts at least a portion of the emanating radiation, which imposes amplitude modulation on the radiation, depending on the rotational velocity, the size of the apertures (402), the percentage of the beam that is intercepted by the apertures (402), and the spacing apart of the apertures (404). Further, the apertures (402) are either along the edge of the chopping wheel (400), or are fully encircled by the chopping wheel. Further, a chopping frequency is imposed by the wheel (400) and the one or more apertures (404), which alternately block and transmit the radiation.

Accordingly, the energy of the modulated, diffused laser beam illuminates a candidate target, and illuminates a receiver (102) located at the candidate target. The unmodulated reflector (304) at the receiver (102) reflects illumination back to the source, where the operator observes that the reflected illumination varies in amplitude in synchronization with the modulation imposed by rotation of the chopping wheel (400). Further, the rotational velocity of the chopping wheel (400) is kept constant or is varied under the control of the operator. For example, the operator varies the rotational velocity, and further observes whether the reflected illumination exhibits an amplitude that varies in corresponding synchronization with the varied rotational velocity of the chopping wheel (400). Thus, the operator verifies that the reflector (304) at the receiver (102) is reflecting the modulated radiation that originates from the correct source, the correct source being the laser (300).

A battery powered laser pointer (300) is used as the laser (300). The chopping wheel (400) is a mechanical shutter that is rotated by hand or, alternatively, is rotated by a battery powered electric motor (406). Thereby, the electronic requirements of the invention are simplified for low cost production and for simplified field use.

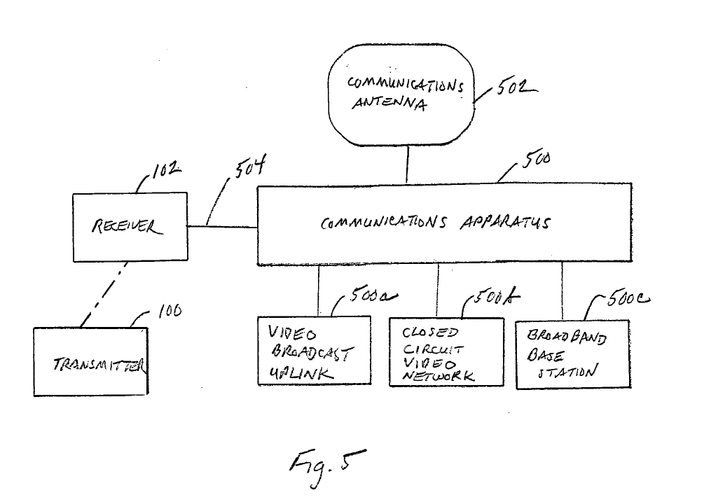

FIG. 5 discloses a broadband communications apparatus (500) having an external communications antenna (502) for transmitting and/or receiving wireless broadband communications signals. For example, the communications apparatus (500) includes, but is not limited to, a video broadcast uplink (500a), a closed circuit video network (500b) and a broadband base station (500c) for establishing wireless broadband communications. The video broadcast uplink (500a) provides video broadcast coverage of events, such as, sporting events, which are relayed by the communications antenna (502) to a communications satellite. The closed circuit video network (500b) establishes video conferencing communications, or point-to-point video surveillance communications. The broadband base station (500c) processes broadband signals, such as, video, Internet and voice over Internet protocol and transmits and receives the same via the communications antenna (502).

The laser aligned transmitter or receiver (100) establishes wireless communications with the receiver or transceiver (102), in turn, transmitting such communications over a communications link (504) with the communications apparatus (500). The communications link (504) includes, but is not limited to, a network connection, a direct link by wire or optical cable and a wireless link. The wireless link typically is established via the antenna (502).

Although the invention has been described in terms of exemplary embodiments, it is not limited thereto. Rather, the appended claims should be construed broadly, to include other variants and embodiments of the invention, which may be made by those skilled in the art without departing from the scope and range of equivalents of the invention.

What is claimed is:

1. A method of aligning a transmitter and receiver for line-of-sight wireless communications, comprising the steps of:
pointing an emanating pointer beam of a laser pointer toward a receiver to illuminate the receiver with a visually observed bright spot;
reflecting the pointer beam from a reflector positioned substantially along a line-of-sight with the receiver;
observing a reflected pointer beam as being within the visually observed bright spot to confirm that the pointer beam is aligned substantially along the line-of-sight, and
fixing the transmitter in place with the transmitter output aligned substantially along the line-of-sight.

2. The method as in claim 1, further comprising:
linking the receiver with a communications apparatus for processing and routing broadband communications signals.

3. The method as in claim 1 wherein,
the step of reflecting the pointer beam from a reflector positioned substantially along a line-of-sight with the receiver, further comprises the step of, reflecting the pointer beam with a corner cube reflector.

4. The method as in claim 1, further comprising:
observing the bright spot as having the reflected pointer beam with the visually recognized modulation to confirm that the pointer beam is aligned substantially along the line-of-sight.

5. The method as in claim 1, further comprising:
modulating the pointer beam with a coded modulation; and
observing the bright spot as having the reflected pointer beam with the coded modulation to confirm that the pointer beam is aligned substantially along the line-of-sight.

6. The method as in claim 1, further comprising:
modulating the pointer beam for intermittent emanation; and
observing the bright spot as having the reflected pointer beam with the intermittent emanation.

7. The method as in claim 1, further comprising:
modulating the pointer beam with an electronically encoded modulation; and
observing the bright spot as having the reflected pointer beam with the electronically encoded modulation.

8. The method as in claim 1, further comprising:
aligning the emanating pointer beam substantially along a line-of-sight of the transmitter output prior to illuminating the receiver with the visually observed bright spot.

9. The method as in claim 1, further comprising:
aligning the emanating pointer beam substantially along a line-of-sight of the transmitter output by mounting the pointer beam on the transmitter prior to illuminating the receiver with the visually observed bright spot.

10. The method as in claim 1, further comprising:
diffusing the emanating pointer beam to enlarge the bright spot to be observed.

11. An alignment mechanism for establishing line-of-sight alignment between a transmitter and a receiver comprising:
a laser pointer that emanates a laser beam along a line-of-sight to illuminate a receiver with a bright spot;
a reflector at the receiver to reflect the emanated laser beam for return path transmission toward the laser pointer to confirm an alignment of the line-of-sight with the receiver; and
a transmitter aligned substantially along the alignment confirmed by the reflected laser beam.

12. The alignment mechanism according to claim 11, further comprising:
a communications apparatus including, but not limited to, a video broadcast uplink, a closed circuit video network or a broadband base station; and the receiver and the communications apparatus being linked by a communications link.

13. The alignment mechanism according to claim 11 wherein, the laser pointer is mounted on the transmitter.

14. The alignment mechanism according to claim 11, further comprising:
a diffuser to diffuse the emanated laser beam.

15. The alignment mechanism according to claim 11, further comprising:
a modulator to modulate the emanated laser beam.

16. The alignment mechanism according to claim 11, further comprising:
a shutter to modulate the emanated laser beam for intermittent transmission.

17. The alignment mechanism according to claim 11, further comprising:
a motor driven shutter to modulate the emanated laser beam for intermittent transmission.

18. The alignment mechanism according to claim 11, further comprising:
a chopping wheel to modulate the emanated laser beam with a varied amplitude.

19. The alignment mechanism according to claim 11, further comprising:
a chopping wheel to modulate the emanated laser beam with a varied amplitude; and
a motor to rotate the chopping wheel.

20. The alignment mechanism according to claim 11 wherein, the reflector is a non-modulating reflector.

21. The alignment mechanism according to claim 11 wherein, the reflector is a retroreflector.
